(19) United States
(12) Patent Application Publication
(10) Pub. No.: US 2016/0082546 A1
(43) Pub. Date: Mar. 24, 2016

(54) DEVICE FOR PREHEATING DURING WELDING AND METHOD

(71) Applicant: SIEMENS AKTIENGESELLSCHAFT, München (DE)

(72) Inventor: BERND BURBAUM, FALKENSEE (DE)

(21) Appl. No.: 14/787,794

(22) PCT Filed: Apr. 11, 2014
(86) PCT No.: PCT/EP2014/057396

§ 371 Date: Oct. 29, 2015

(30) Foreign Application Priority Data
May 6, 2013 (EP) 13166606.7

(51) Int. Cl. B23K 26/06; B23K 26/21

(52) U.S. Cl. CPC B23K 26/0608; B23K 26/21; B23K 26/0648

(57) ABSTRACT

By the use of two lasers which are not mechanically connected to each other but the beams of which are then coupled to each other, it is possible to carry out preheating and remelting or melting in a very simple manner is provided.

### CROSS-REFERENCE TO RELATED APPLICATIONS

This application claims priority to PCT Application No. PCT/EP2014/057396, having a filing date of Apr. 11, 2014, based off of European Application No. 13166606.7, having a filing date of May 6, 2013, the entire contents of which are hereby incorporated by reference.

### FIELD OF TECHNOLOGY

The following relates to a device which is used for welding, and to a method for welding and preheating.

### BACKGROUND

During remelting or deposition welding of metallic materials, in particular of brittle materials such as nickel-based superalloys, it is necessary to avoid hot cracking during the solidification process.

In order to avoid this, use is frequently made of preheating which is achieved by means of induction loops. However, this is rather onerous and difficult to adapt for certain regions of complex geometries.

Embodiments of the present invention therefore has an advantage of proposing a system and method which is simpler to carry out and can adapt flexibly to complex geometries.

### SUMMARY

The advantages of the device and of the method reside in a simplification of the plant technology and a reduction in or elimination of hot cracking.

### Some of the embodiments will be described in detail, with reference to the following figures, wherein like designations denote like members, wherein:

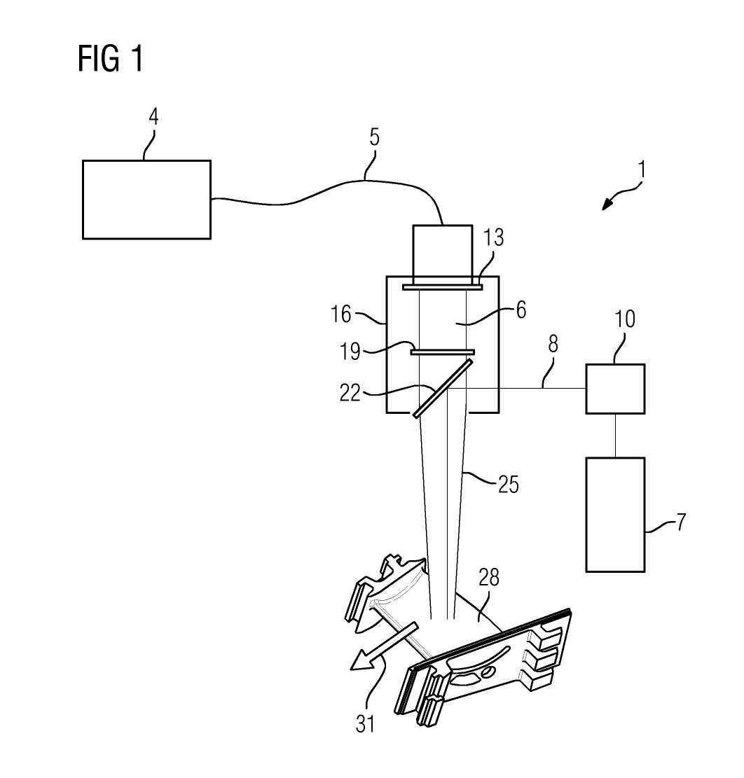

FIG. 1 shows an example of a device according to the invention;

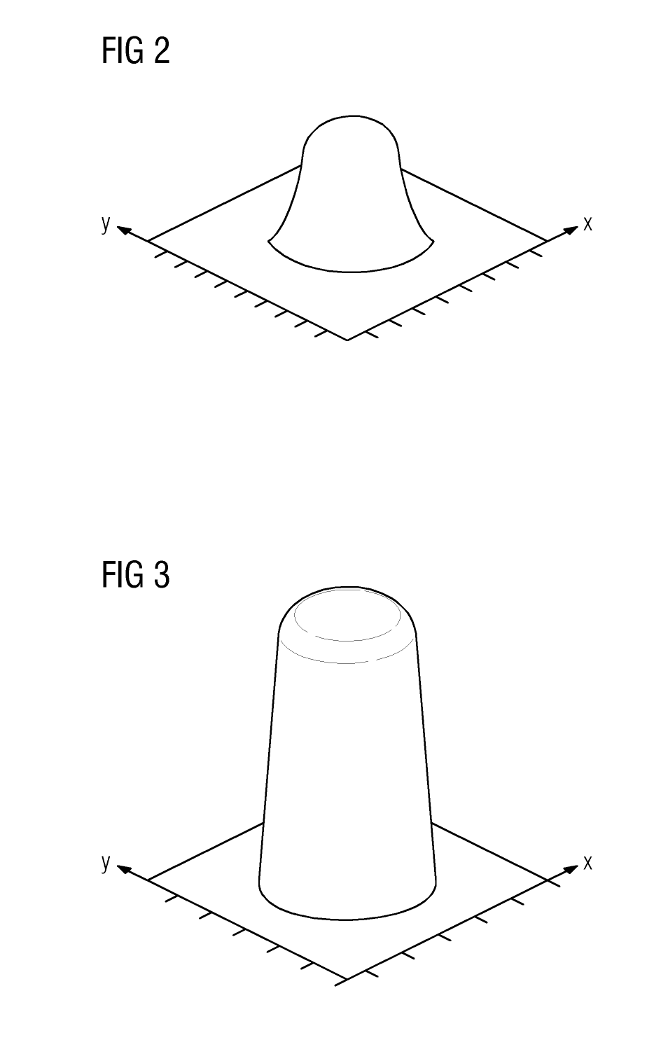

FIGS. 2 shows an intensity distributions; and

FIG. 3 shows an intensity distribution

The figure and the description represent only exemplary embodiments of the invention.

### DETAILED DESCRIPTION

The device 1 has two lasers 4, 7, in particular only two lasers 4, 7.

The first laser 4 is used for preheating while the second laser 7 is used for remelting.

The first laser 4 couples its laser beams 6, in particular via a fiber 5, into an optical system 16 inside which is a collimating lens 13 and a focusing lens 19.

The second laser 7 couples its laser beams 8 via a scanner 10 and via a dichroic mirror 22 into a common laser beam 25 so as to result in a desired temperature radiation. This produces a laser beam 25 onto a surface of a component 28.

Preferably, two laser beams 6, 8 are coupled-in in the optical system 16, wherein the wavelength of the first laser 4 is 800 nm to 1000 nm and the wavelength of the second laser 7 is 1000 nm to 1100 nm.

The first laser 4 contributes to preheating the component 28 and has a Gaussian intensity distribution as shown in figure 2.

For the remelting process or deposition process, the laser radiation 8 of the second laser 7 is directed away by means of a scanner 10 and, together with the laser beam 25, is guided in a direction 31 over the component 28.

It is thus possible for preheating to take place at almost any point—including in the transition region—between the blade airfoil and the blade platform.

FIG. 3 shows the intensity distribution of the laser beams 8. The laser beam 8 is arranged within the laser beam 6.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1-8. (canceled)

9. A device for laser welding, having at least:
one first laser,
one second laser,
wherein the laser beams of the first laser and the laser beams of the second laser are coupled together by means of an optical unit into one laser beam,
in which the laser beams of the second laser can be directed via a scanner and a dichroic mirror together with the laser beams of the first laser onto a component.

10. The device as claimed in claim 9, in which the wavelength of the laser beams of the first laser is between 800 nm and 1000 nm.

11. The device as claimed claim 9, in which the wavelength of the laser beams of the second laser is between 1000 nm and 1100 nm.

12. The device as claimed claim 9, wherein the optical unit has a collimating lens and a focusing lens.

13. A method for laser welding, in which in particular use is made of a device as claimed in claim 9, wherein a first laser beam for preheating is guided, together with a second laser beam for melting or remelting, over a component.

14. The method as claimed in claim 9, which the wavelength of the laser beams of the first laser is between 800 nm and 1000 nm.

15. The method as claimed in claim 9, in which the wavelength of the laser beams of the second laser is between 1000 nm and 1100 nm.
